(19) United States
(12) Patent Application Publication
(10) Pub. No.: US 2010/0154720 A1
(43) Pub. Date: Jun. 24, 2010

(54) DOG TRAINING DEVICE

(76) Inventor: Steven Handelin, Minden, NV (US)

Correspondence Address: LEWIS AND ROCA LLP, 1663 Hwy 395, Suite 201, Minden, NV, 89423, US

(21) Appl. No.: 12/341,923

(22) Filed: Dec. 22, 2008

(51) Int. Cl. A01K 15/02

(52) U.S. Cl. 119/712

(57) ABSTRACT

A training device used to train a retrieving dog. The device comprises a head, wings, and a body. The body is configured to have a shape that is similar to that of a duck or other bird, while be easy to throw. The body may be constructed out of an American football.

### FIELD OF THE INVENTION

The present invention relates to a device for training dogs. Particularly, the present invention relates to a device that helps train retrieving dogs. More particularly, the present invention relates to a device shaped like a bird used to train a retrieving dog to retrieve a bird.

### BACKGROUND OF THE INVENTION

Training a retrieving dog can be a time consuming project. Many devices have been used to make the training easier. Such devices include objects that are made to look similar to the bird of choice and are thrown for the dog to retrieve. These devices must be thrown over and over again in order to train the dog. Therefore, a device is needed that is easy to throw, relatively simple to construct, and is one which the dog is able to pick up and carry.

### SUMMARY OF THE INVENTION

The present invention is a device used in training a hunting dog to receive a bird that has been shot.

In one exemplary embodiment of the present invention, the receiving device comprises a head, a body, and two wings. It may also include a tail, and feet. In accordance with an aspect of the present invention, the body is preferably a shape that looks similar to the body of a bird, while being easy to throw.

In one preferred embodiment, the shape of the body is an ellipsoid. More preferably, the shape of the body is a prolate spheroid. Yet even more preferably, the body may be formed using an American football, or an object of similar form and shape.

In other exemplary embodiments, the head is attached by a flexible rope or cord and the head is constructed of a hard material to deter the dog from shaking the device.

In other exemplary embodiments, only select appendages are attached, for example only the head or only wings, or any other variation of the appendages can be used.

In other exemplary embodiments, the head and wings are constructed out of a plush material and are constructed to look similar to the head and wings of a bird.

For a more complete understanding of the nature and various advantages of the present invention, reference should be made to the ensuing detailed description and claims, taken in conjunction with the accompanying drawings.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a depiction of an exemplary embodiment of the present invention;

FIG. 2 is a depiction of a bottom view of an exemplary embodiment of the present invention;

FIG. 3 is a depiction of a side view of an exemplary embodiment of the present invention; and

FIG. 4 is a depiction of a bottom view of another exemplary embodiment of the present invention.

### DETAILED DESCRIPTION OF THE INVENTION

The present invention relates to a device used to train dogs for hunting purposes. The following is a description of exemplary embodiments in accordance with this invention.

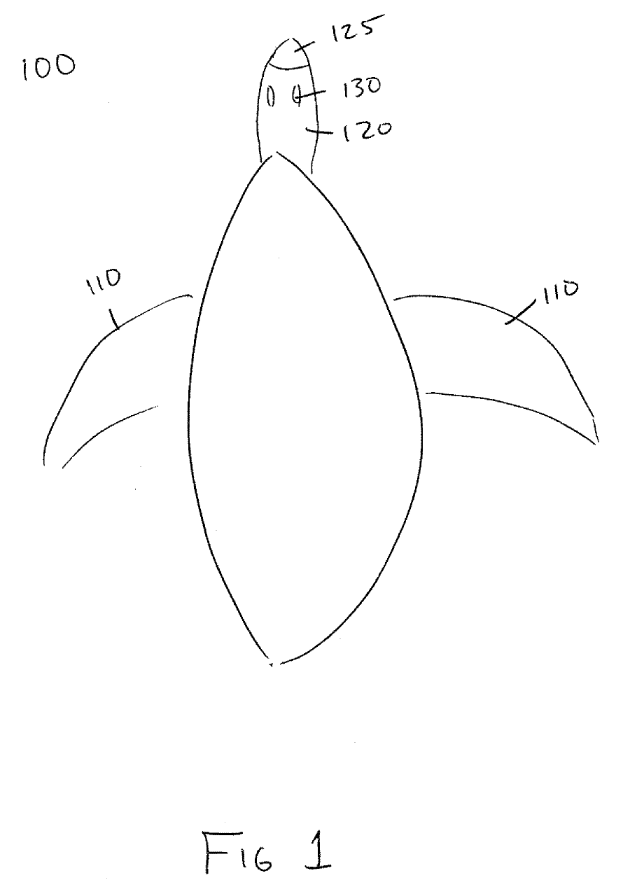

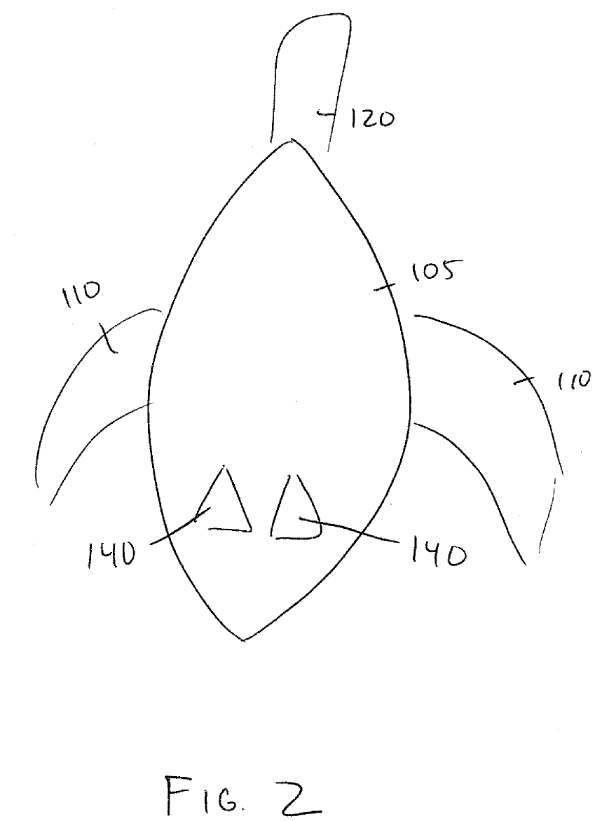

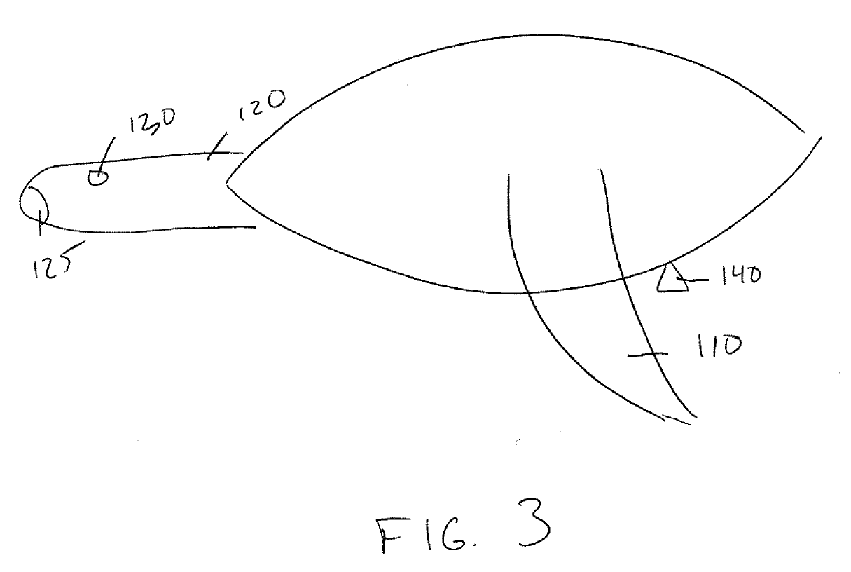

With reference to FIG. 1, a training device 100 according to aspects of the present invention is shown. Training device 100 comprises a body 105, wings 110, and head 120. In addition, as shown in FIGS. 2 and 3, training device 100 may also comprise feet 140.

With continuing reference to FIG. 1, body 105 comprises an elongated body. The body 105 of the training device 100 should comprise a shape that is easy for the user to grip, easy for the user to throw, and having an aerodynamic shape to allow throwing over appreciable distances. In addition, the body 105 should also comprise a shape such that the dog being trained is able to the grip the body 105 with its mouth. In addition, an ideal shape for the body 105 is one that is similar to the natural shape of a duck or other bird.

In accordance with an exemplary embodiment of the present invention, a preferable shape for the body 105 is an ellipsoid. More preferably the shape of the body 105 is a prolate spheroid. Even more preferably, the shape 105 of the body is approximately the shape of an American football or an object of similar form and shape.

In one exemplary embodiment of the present invention, the body 105 of the training device is formed from an American football or American football-shaped object. Any type of American football or similar object may be used as the body 105. For example, the football may be the equivalent of a college-regulation-sized football, a junior-sized football, or a miniature sized American football. The body may be constructed or formed from a variety of materials, such as leather, synthetic leather, plush, plastic and/or foam materials, hollow or solid. In some embodiments, the body should be formed such that it will float, and in other embodiments, the body should be formed such that it will not float. The body can also be formed using a resilient bladder formed from rubber or similar materials, with a cover formed from plush material or other material.

In addition, any material commonly used for footballs may be used. Preferably, a material would be used that could withstand the rigors of the being used as a training device. For example, it would be preferable to use a leather or synthetic leather football as the body, or a plastic or foam material could be used as the construction of the body. In addition, laces or similar surface features to facilitate gripping for throwing may be provided on the surface of the body.

The body may also have any design on the body. As an example, the body 105 may comprise a typical brown football. On the other hand, the body may be designed to bring attention to the body. For example, the body 105 may be designed to look similar to the body of a particular bird, or the body may be designed with bright colors to attract the attention of the dog being trained, or be designed to reflect the color scheme of a particular bird. In addition, the body 105 may comprise added material to make the body look more like a duck or other bird. For example, the body may be covered with a plush material, synthetic feathers, or the like in order to make the body 105 look more like a bird. Furthermore, the football or object of similar form and shape may contain laces typically found on an American football to make the training device 100 easier to throw.

The interior of the body 105 may comprise any material so long as the device is able to be thrown by the user. In one embodiment, the interior of the body 105 is hollow and is filled with air. Other materials may be used, however, to give the training device a more life-like feel. In addition, the interior of the body 105 may be lined with a protective coating to help prevent holes forming from dog bites or from other instances of normal wear and tear.

With continued reference to FIG. 1, training device 100 also comprises a head 120. The head is preferably attached to the body 105 at one of the pointed ends of the football shape or object of similar form and shape.

The head is preferably configured to look similar to the head and neck of a duck or other particular bird. For example, head 120 may comprise eyes 130 and beak 125. In addition, head 120 may be colored similar to that of a real duck or other particular bird.

Head 120 is preferably made out of material that can withstand the rigors of training. In a preferred embodiment of the present invention, the head 120 is made of a plush material, such as, for example, the material that commonly is used on the exterior surfaces of a stuffed animal. In other embodiments of the present invention, the head is covered with a material that makes the training device appear more life-like, such as, for example, synthetic feathers. In other embodiments of the present invention, the head is constructed of a hard and rigid matter and attached with a flexible rope or cord to the body to deter the dog from shaking the device.

The interior portion of head 120 may filled with any material that supports the head and can withstand the rigors of training. Examples of such material include, for example, straw, beans, plastic pellets, cotton, and synthetic fibers.

The head 120 may be attached to the body 105 in any way that will withstand the elements of training. Examples include, but are not limited to, glue, sewing, snaps, buttons, and the like. In an exemplary embodiment, the head is attached to the body by sewing the head into the body. Preferably when sewed, a thread that can withstand the rigors of training is used. It should also be noted that more than one method of attachment may be used. For example, the head may be glued and sewn to the body.

In an exemplary embodiment of the present invention, training device 100 also comprises wings 110. The wings are preferably attached to the body 105 approximately mid way between the two pointed ends of the football shaped body 105, with one wing being on each side of the ball/body, as shown in FIG. 1.

Similar to the head 120, the wings 110 in one embodiment are comprised of a plush material, but can be comprised of any material that can withstand the rigors of dog training. The wings may be colored to look like similar to the wings of a duck or other particular bird and may also be covered with material, such as, for example, synthetic feathers, to make the training device look life like.

The wings 110 may be attached in any of the fashions mentioned above for the head 120. Preferably, the wings are attached by sewing the wings to the body 105 with a thread.

According to aspects of an exemplary embodiment of the present invention, the training device may also comprise feet 140. With reference to FIG. 2, feet 140 are positioned on the under side of the training device. Preferably the feet are approximately ¾ of the length of the body away from the head. Although, it should be noted that the feet can be located any distance from the head.

Similar to the head and wings, feet 140 may be made from a plush material and are attached by sewing the feet to the body 105 with thread. The feet may be colored to make the feet similar to that of an actual duck or other particular bird. Any of the materials and attachment methods mentioned for the wings and head may also be used for the feet 140.

In some embodiments, the various appendages may be formed from a harder less attractive material. Use of such material will induce the dog to avoid the harder material and discourage the dog from shaking the bird, an undesirable trait in a hunting dog.

According to one aspect of the present invention, the appendages may be attached to the body by means such as buttons, snaps, hook-and-loop fasteners, and other removable fastening means so that interchangeable kits including a single body and appendage kits for various birds, for example, a duck and a pheasant could be bundled together, or separately provided. Such interchangeable kits may include a tail appendage to aid the dog in recognizing birds, such as pheasants, that have prominent tails.

According to another aspect of the invention, the body (or appendages) may have provision for application of scents, either by rubbing them onto the body or appendage or by providing a pocket or other recess to hold scent media.

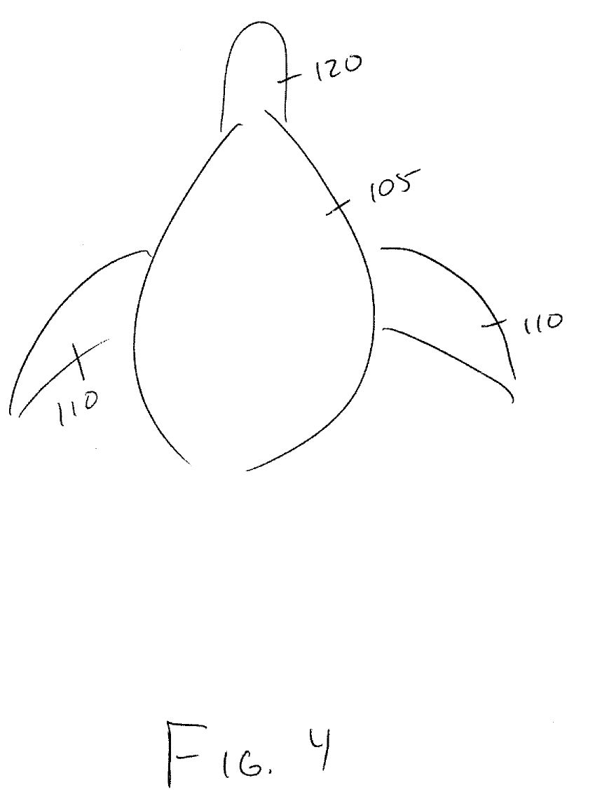

Another exemplary embodiment of the present invention is shown in FIG. 4. As can be seen in this drawing, training device 100 may use a smaller American football or object of similar form and shape, and junior sized football, for example, than the exemplary embodiment shown in FIG. 1-3. Also, as seen in FIG. 4, this particular embodiment does not include feet.

It should be noted that, although the embodiments illustrated above refer to ducks, any type of bird may be used to model the training device after. Therefore, a training device according to the present invention may be used to train dogs to hunt for birds other than ducks.

According to another aspect of the present invention, a transducer providing sounds of one or more game birds may provided in the body or in an appendage.

Although the above provides a full and complete disclosure of the preferred embodiments of the invention, various modifications, alternate constructions and equivalents will occur to those skilled in the art. Therefore, the above should not be construed as limiting the invention, which is defined by the claims.

What is claimed is:

1. A device for training retrieving dogs comprising:
a body;
a head; and
at least one wing;
wherein the shape of the body is an ellipsoid.

2. The device of claim 1, wherein the shape of the body approximately mirrors the shape of an American football.

3. The device of claim 2, wherein the body comprises an American football.

4. The device according to claim 1, further comprising feet.

5. The device according to claim 1, wherein the head is made from a plush material.

6. The device according to claim 5, wherein the head is attached to the body by sewing the head to the body with a thread.

7. The device according to claim 1, wherein the at least one wing is made from a plush material.

8. The device according to claim 7, wherein the at least one wing is attached to the body by sewing the at least one wing to the body with a thread.

9. A device used to train receiving dogs comprising:
a body;
a head; and
two wings;
wherein the body is constructed from an American football.

10. The device according to claim 9, wherein the head is configured to look similar to the head of a bird.

11. The device according to claim 10, wherein the bird is a duck.

12. The device of claim 11, wherein the head is made from a plush material.

13. The device of claim 9, further comprising two feet.

14. The device of claim 9, further comprising a tail.

15. The device of claim 9, further comprising a head constructed of a hard material and attached to the body with a flexible material.
